(19) United States
(12) Patent Application Publication
(10) Pub. No.: US 2004/0221709 A1
(43) Pub. Date: Nov. 11, 2004

(54) Music machine

(76) Inventor: Rodrigo Antonio Tonet, Campo Mourao (BR)

Correspondence Address: WELSH & KATZ, LTD, 120 S RIVERSIDE PLAZA, 22ND FLOOR, CHICAGO, IL, 60606, US

(21) Appl. No.: 10/429,489

(22) Filed: May 5, 2003

(51) Int. Cl. G10H 7/00

(52) U.S. Cl. 84/602

(57) ABSTRACT

MUSIC MACHINE, which works with the use of a computer interconnected to a center server (remote computer), through Internet, Intranet and other kinds of computer net, utilizing a common telephone line, connections like “wide band” ones, such as ADSL, ISDN, Internet by radio, cable modem, by satellite, cell phone and other similar connections.

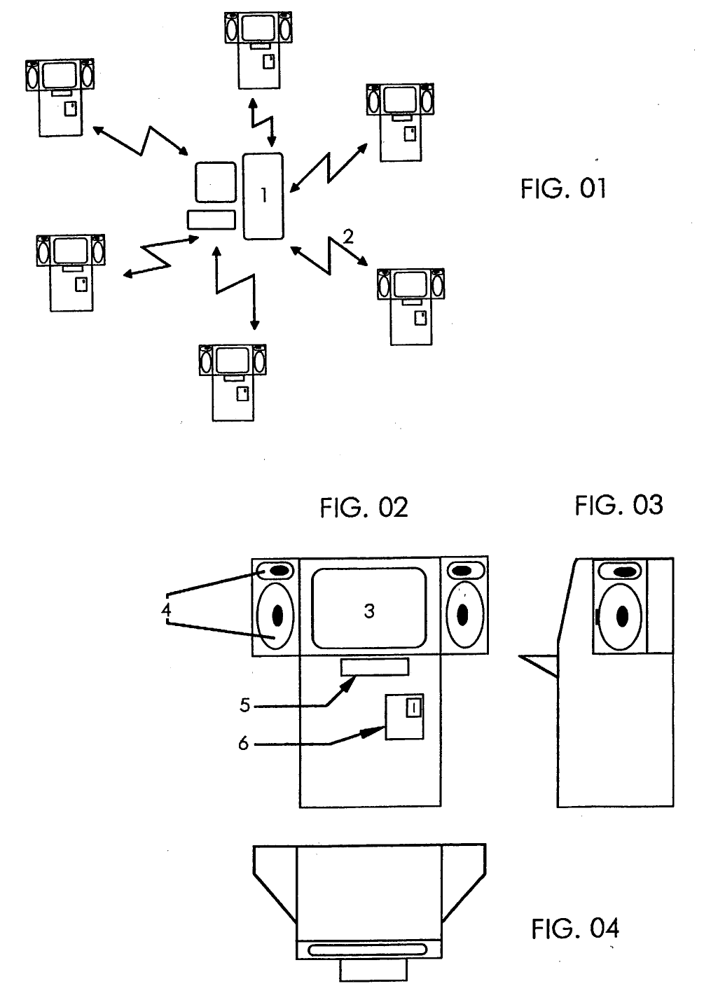

### SUMMARY

The following descriptive report of the invention patent is about the development of a music machine (internet music box), which works with the use of a computer interconnected to a central server (remote computer) through the Internet, Intranet and other kinds of computer network, using a common telephone line, connections like “wide band” ones, such as ADSL, ISDN, Internet by radio, cable modem, by satellite, cell phone and other kinds of similar connections. In that manner, the songs played in the “Internet music box”, are not filed in your hard disk, but in the central server (remote computer).

Thus, the machine plays all songs in “streaming”, that is, it only repeats the song that is being played in the remote computer, but this song won't be recorded in the machine hard disk (the file is recorded in a volatile way as a temporary file, which will be deleted in a predetermined period after its use).

In that manner, the pile available is nearly unlimited, since the possibilities of the server expansion are unlimited. Thus, the machine offers to the user the possibility of choosing a song from among an unlimited quantity of songs.

Besides playing music, the machine is able to show video clips, animation, publicity films, as well as events transmitted by Internet, Intranet, such as movies, news, games and so on.

Features

The machine is made up of a cabinet where there is: a monitor (image tube, plasma or crystal liquid screen), a set of loudspeakers, a computer, software (operational system and specific software for the employment), collection system (with chips, coins, bills, magnetic cards, credit cards, payment by cell phones and with the use of passwords), net access dispositives (modem, cable modem, ADSL modem, ISDN modem, radio, net plate) and sound amplification systems.

The system used allows the control from afar of each machine, so that we may know the number of songs played, which songs were played, who the singers are and the copyright detainers of the songs played. It's also possible to make a report for the copyright collection, reports of the songs played for charging the system lessors and users, know how much the machines are being used, song search mechanisms (by song title, singer, the CD original title, recording year), show publicity in the machines screens, system support from afar (only software).

Technique State

The old “Juke box” machines played music from long plays, chosen by the users, by a chip, coin or another payment way. The latest models use Cds. And more recently, songs are stored in the computer hard disk, which has the capacity of storing a quantity of songs from over a hundred Cds. This newest technology was possible by the use of music compacted files, MP3 being the most popular one.

Advantages

The “Internet music box” main advantage is the utilization of internet resources for accessing the remote pile, that is, the machine uses the server pile (which is unlimited), without the need of new releases updating. So that the establishment owner (renter or partner), or the machine operators (machine owners or franked people) don't need investments for updating, since those investments are for the account of the server owner. As the songs aren't recorded in the hard disk, there are no copies of them, therefore this is not illegal; the machine operators have the on-line control of all machines they own, and are able to send a banking charge, through credit cards or another ways directly to the renter or partner. There is a possibility of centralizing the copyright collection, through played songs reports.

Functional Description

The machine works the following way: the user (client who wants to listen to a song in particular), operates, by the machine keyboard, the system search which finds the wanted song (by the name of the song, singer, band, the CD original name, rhythm, kind, recording year or any other information about the song). It's possible to try with the accurate information or just part of it. The machine computer consults the central server data bank which sends a list with all the songs that satisfy the user's imposed condition, for example: the user types “My way” in the space “song”, the server will provide a list with all “My way” versions; but if the user also types “Frank Sinatra” in the space “singer”, the server will provide a list with all “My way” versions sung by “Frank Sinatra”. If the user types only “Frank Sinatra” in the space “singer”, the server win provide a list with all Frank Sinatra's songs available. Once the songs list is shown (or only the right song), the user confirms the wanted song and by a chip deposit or confirmation through other means of collection, the machine informs the server the wanted song. Thus, the server searches this song in its data bank and starts playing it. Then the machine catches the song and through the utilized network plays it for the user and for all over the place where it's being played, through its sound system. Meanwhile (streaming process) the machine will create a kind of temporary volatile file (internet temporary files) in its HD, which will be deleted afterwards. During this procedure, the server system stores all the information given (which net machine was used, what song was played, how much money was collected and so on), so that the charge reports for the parts can be made (renters, partners, franked people, etc.)

### DRAWINGS DESCRIPTION

The characterization of the patent invention here proposed, is made through representative drawings of the music machine, so that the machine or equipment can be easily reproduced with the adequate technique, allowing the total characterization of the object performance. From the elaborated drawings, which express the best way or preferred way to achieve the product here idealized, comes the basis of the report descriptive part, through a detailed and sequential numeration, where aspects that can be perceived by the adopted representation are cleared up.

These drawings are merely illustrative, and they can show variations. As long as everything is followed as initially required, we have:

DRAWING 1 It illustrates the operation scheme, where several machines are interconnected to a central server

DRAWING 2 It illustrates schematic orthogonals of the proposed machine.

### ALLEGATIONS

Music machine, which works with the use of a computer interconnected to a central server (1) through Internet, Intranet and other kinds of computer network, utilizing some kind of connection (2) like “wide band” ones, such as ADSL, ISDN, internet by radio, cable modem, by satellite, cell phone, where the songs to be played are stored in the central server (remote computer), so that the machine plays the songs in a sequence (streaming), repeating the song which is being played in the remote computer, and this song won't be recorded in the machine hard disk. Music machine, made up of a cabinet where there is: a monitor (3) associated with a set of loudspeakers (4), a computer with access by keyboard (5) containing specific software for the employment, collection system (6) like a card file, net access dispositives and sound amplification systems.

Music machine, whose system allows the control from afar of each machine. It will be possible to know the quantity of the songs played, which songs were played, the singers and the copyright detainers of the songs played. The machine can make reports for the copyright collection, reports of the songs played for charging the system renters and users, allowing people to know how much the machines have been used, the song search mechanisms showing publicity in the machines screens and with the system support from afar (only software).

1- MUSIC MACHINE, distinguished for working with the use of a computer interconnected to a central server (1) through Internet, Intranet and other kinds of computer network, utilizing some kind of connection (2) like “wide band” ones, such as ADSL, ISDN, internet by radio, cable modem, satellite, cell phone, where the songs to be played are stored in the central server (remote computer), so that the machine plays the songs in a sequence (streaming), repeating the song that is being played in the remote computer (1), and this song won't be recorded in the machine hard disk.

2- MUSIC MACHINE, as revindicated in 1 and distinguished for being made up of a cabinet where the following is stored: a monitor (3) associated with a set of loudspeakers (4), a computer with access by keyboard (5) containing specific software for the employment, collection system (6) like a card file, net access dispositives and sound amplification systems.

3- MUSIC MACHINE, as revindicated before and distinguished for allowing the control of each machine from afar, and also allowing to know the quantity of songs played, which songs were played, who the singers are, the copyright detainers of the songs played, preparing reports for the copyright collection, reports of the songs played for charging the system renters and users. It's also possible to know how much the machine has been used, the song search mechanisms showing publicity in the computer screens and with the system support from afar (only software).
